(19) United States
(12) Patent Application Publication
(10) Pub. No.: US 2023/0411675 A1
(43) Pub. Date: Dec. 21, 2023

(54) LITHIUM-ION BATTERY

(71) Applicant: ZHUHAI COSMX BATTERY CO., LTD., Zhuhai (CN)

(72) Inventors: Yanan FAN, Zhuhai (CN); Jiajiang ZENG, Zhuhai (CN); Liqiu YU, Zhuhai (CN); Zhiqiang TONG, Zhuhai (CN); Suli LI, Zhuhai (CN)

(73) Assignee: ZHUHAI COSMX BATTERY CO., LTD., Zhuhai (CN)

(21) Appl. No.: 18/459,818

(22) Filed: Sep. 1, 2023

Related U.S. Application Data
(63) Continuation of application No. PCT/CN2022/093487, filed on May 18, 2022.

(30) Foreign Application Priority Data
Jun. 21, 2021 (CN) 202110687062.4

(51) Int. Cl. H01M 10/0525; H01M 4/131; H01M 4/66

(52) U.S. Cl. CPC H01M 10/0525; H01M 4/131; H01M 4/661; H01M 2300/002

(57) ABSTRACT

Disclosed is a lithium-ion battery, where the lithium-ion battery includes a positive electrode active material, and the positive electrode active material includes lithium cobalt oxide particles doped with one or more elements of Al, Mg, Ti, Zr, Ni, Mn, Y, La, Sr, W, or Sc. When the lithium-ion battery is in an SOC of 0%, a molar ratio of an element lithium to an element cobalt in the positive electrode active material is A, and when the lithium-ion battery is in an SOC of 100%, a molar ratio of the element lithium to the element cobalt in the positive electrode active material is B, where 0.62≤(A−B)≤0.655. The lithium-ion battery provided in the present disclosure has good cycling performance at a high voltage.

### CROSS-REFERENCE TO RELATED APPLICATIONS

This application is a continuation of International Application No. PCT/CN2022/093487, filed on May 18, 2022, which claims priority to Chinese Patent Application No. 202110687062.4, filed on Jun. 21, 2021. The disclosures of the aforementioned applications are hereby incorporated by reference in their entireties.

### TECHNICAL FIELD

The present disclosure relates to a lithium-ion battery, and to the field of secondary battery technologies.

### BACKGROUND

Since lithium-ion batteries have been commercialized, they are widely used in digital fields such as notebooks and mobile phones due to their high specific energy and good cycling performance. However, with continuous improvement of human requirements on electronic devices, higher requirements are also put forward on the energy density of the lithium-ion batteries. The energy density of the lithium-ion batteries is closely related to the volume, discharge voltage platform, and discharge capacity of the lithium-ion batteries, and therefore, improving the discharge voltage platform of the lithium-ion batteries becomes one of effective means for improving the energy density.

However, when a lithium-ion battery charges to 4.2 V or more, lithium ions in a positive electrode active material LiCoO₂ are deintercalated and form Li₁₋ₓCoO₂ (0≤x≤0.5). When a charging voltage is increased to 4.4 V or more, more lithium ions are deintercalated from the positive electrode active material. After the lithium ions are deintercalated, LiCoO₂ is also continuously converted from a hexagonal system to a monoclinic system, and the converted LiCoO₂ of the monoclinic system no longer has reversible lithium ion deintercalation capacity. In addition, when the charging voltage of the lithium-ion battery reaches 4.4 V or more, a side reaction of the positive electrode active material and an electrolyte is gradually exacerbated. Therefore, with the continuous increase of the charging voltage, the reversible capacity of the positive electrode active material is continuously reduced, which causes cycling performance of the lithium-ion battery to become poor, and limits application of the lithium-ion battery. This is also one of the important reasons that a reversible capacity of a positive electrode active material lithium cobalt oxide used commercially at present is far less than its theoretical capacity (274 mAh/g). Therefore, how to improve cycling performance of a lithium-ion battery at a high voltage becomes a technical problem urgently to be solved by a person skilled in the art.

### SUMMARY

The present disclosure provides a lithium-ion battery, which has excellent cycling performance at a high voltage.

The present disclosure provides a lithium-ion battery, where the lithium-ion battery includes a positive electrode active material, and the positive electrode active material includes lithium cobalt oxide particles doped with one or more elements of Al, Mg, Ti, Zr, Ni, Mn, Y, La, Sr, W, or Sc. When the lithium-ion battery is in a state of charge (SOC) of 0%, a molar ratio of an element lithium to an element cobalt in the positive electrode active material is A, and when the lithium-ion battery is in an SOC of 100%, a molar ratio of the element lithium to the element cobalt in the positive electrode active material is B, and 0.62≤(A−B)≤0.655.

SOC is an abbreviation of state of charge, which refers to an available state of remaining charges in a battery, and SOC=Qᵣₑₘₐᵢₙ/Q_{rated}*100%, where Q_{rated} denotes a rated capacity of the battery, and Qᵣₑₘₐᵢₙ denotes remaining charges in the battery. In general, 0% SOC represents a state of empty charge, which is generally a state of 3.0 V for an LCO (lithium cobalt oxide) material; and 100% SOC represents a state of full charge of the battery.

The present disclosure provides a lithium-ion battery, including a positive electrode active material. The positive electrode active material includes lithium cobalt oxide particles doped with one or more elements of Al, Mg, Ti, Zr, Ni, Mn, Y, La, Sr, W, or Sc. Performing element doping on the lithium cobalt oxide particles helps to improve structural stability of the positive electrode active material. In addition, the structural stability of the positive electrode active material is also affected by a charge and discharge regime. When a lithium-ion battery including the foregoing positive electrode active material is charged and discharged by using a specific charge and discharge regime, in an SOC of 0%, a molar ratio of an element lithium to an element cobalt in the positive electrode active material is measured and denoted as A; and in an SOC of 100%, a molar ratio of the element lithium to the element cobalt in the positive electrode active material is measured and denoted as B. When 0.62≤(A−B)≤0.655, it indicates that in the charge and discharge regime, for the lithium-ion battery including the positive electrode active material, the positive electrode active material has good structural stability, and the lithium-ion battery including the positive electrode active material has good cycling performance; otherwise, cycling performance of the lithium-ion battery cannot satisfy a usage requirement, and the positive electrode active material or the charge and discharge regime needs to be adjusted correspondingly to satisfy 0.62≤(A−B)≤0.655. The high voltage mentioned in the present disclosure means that a charge cut-off voltage of a lithium-ion battery is 4.4 V or more. In conclusion, the present disclosure provides a lithium-ion battery. When the lithium-ion battery is in an SOC of 0%, a molar ratio of an element lithium to an element cobalt in the positive electrode active material is A, and when the lithium-ion battery is in an SOC of 100%, a molar ratio of the element lithium to the element cobalt in the positive electrode active material is B. When 0.62≤(A−B)≤0.655, it indicates that the lithium-ion battery has good cycling performance at a high voltage.

In a specific implementation, to improve structural stability of the positive electrode active material, coating may be further performed on the positive electrode active material. Specifically, the positive electrode active material further includes a coating layer covering at least part of an outer surface of the lithium cobalt oxide particles, and the coating layer includes one or more of a metal fluoride, a metal oxide, a metal borate compound, or a metal phosphate compound.

In a specific implementation process, a person skilled in the art may choose to perform doping or perform both doping and coating on the lithium cobalt oxide particles. In the present disclosure, an example in which doping and coating are performed on lithium cobalt oxide particles is mainly used as an example to describe a positive electrode active material in detail. Specifically, the positive electrode active material is prepared by using the following preparation method:
adding an element M to the lithium cobalt oxide particles, where the element M includes one or more of Al, Mg, Ti, Zr, Ni, Mn, Y, La, Sr, W, or Sc; and
covering, with one or more of a metal fluoride, a metal oxide, a metal borate compound, or a metal phosphate compound, at least part of a surface of lithium cobalt oxide particles doped with the element M to form a coating layer, so as to obtain the positive electrode active material.

The present disclosure provides a method for preparing a positive electrode active material. First, element doping is performed on lithium cobalt oxide particles, and then a proper coating material is selected to cover the lithium cobalt oxide particles doped with an element M to obtain a positive electrode active material. The following describes the positive electrode active material in detail with reference to a preparation process.

Step 1: Performing doping of an element M on the lithium cobalt oxide particles, specifically including:

Step 1-1: Dissolving a cobalt source, a complexing agent, and a soluble alkali containing a carbonate in a solvent, mixing and reacting to obtain cobalt carbonate.

Specifically, the cobalt source is selected from one or more of cobalt acetate, cobalt oxalate, cobalt nitrate, cobalt sulfate, cobalt chloride, or cobalt hydroxide. The complexing agent may be aqueous ammonia, and a concentration of aqueous ammonia ranges from 20% to 25%. The soluble alkali containing a carbonate is selected from one or more of Na₂CO₃, NH₄HCO₃, or (NH₄)₂CO₃. The solvent may be deionized water, and the foregoing materials are dissolved in the water. A concentration of the cobalt source ranges from 0.8 mol/L to 3.8 mol/L, and a concentration of the soluble alkali ranges from 0.8 mol/L to 3.8 mol/L. Under an action of the complexing agent, the soluble alkali containing carbonate reacts with the cobalt source to form cobalt carbonate precipitate. A temperature of the reaction ranges from 30° C. to 80° C., and a duration of the reaction ranges from 10 hours to 20 hours.

Step 1-2: Calcining the cobalt carbonate to obtain a precursor.

The cobalt carbonate is calcined at a high temperature to obtain the precursor, where a temperature of the calcination ranges from 920° C. to 1000° C., and a duration of the calcination ranges from 8 hours to 12 hours.

Step 1-3: Mixing and calcining a lithium source, the precursor, and a compound containing an element M.

The lithium source, the precursor, and the compound containing the element M are mixed and calcined to obtain lithium cobalt oxide particles doped with the element M. The lithium source is selected from one or more of lithium hydroxide, lithium nitrate, lithium carbonate, lithium oxalate, lithium acetate, lithium oxide, or lithium citrate. The compound containing the element M is one or more of an oxide, chloride, hydroxide, carbonate, sulfate, nitrate, oxalate, or acetate of the element M.

A temperature of the calcination ranges from 900° C. to 1050° C., and a duration of the calcination ranges from 8 hours to 12 hours.

Step 2: Covering, with one or more of a metal fluoride, a metal oxide, a metal borate compound, or a metal phosphate compound, at least part of a surface of lithium cobalt oxide particles doped with the element M to form a coating layer; and
mixing and calcining the one or more of the metal fluoride, the metal oxide, the metal borate compound, and the metal phosphate compound with the lithium cobalt oxide particles doped with the element M, so that a coating material is covered on at least part of the surface of the lithium cobalt oxide particles, to obtain the positive electrode active material.

The metal fluoride is selected from one or more of AlF₃, Li₃F, or MgF; the metal oxide is selected from one or more of Al₂O₃, TiO₂, ZrO₂, or MgO; the metal borate compound is AlBO₃; and the metal phosphate compound is selected from one or two of AlPO₄ and Li₃PO₄.

A temperature of the calcination ranges from 800° C. to 1000° C., and a duration of the calcination ranges from 6 hours to 9 hours.

To make coating of the coating material more uniform, physical mixing may be performed on the coating material and the lithium cobalt oxide particles doped with the element M before calcination. The physical mixing may be one or more of stirring, ball milling, or grinding, and a duration of the physical mixing ranges from 2 hours to 4 hours.

A thickness of the coating layer should not be too large; otherwise, during charging and discharging, transport of Li⁺ is hindered, thereby affecting rate performance and low temperature performance of the lithium-ion battery. Specifically, the thickness of the coating layer is not greater than 50 nm. A person skilled in the art may control an addition amount of the coating material according to a thickness requirement of the coating layer. Specifically, a mass of the coating layer is not greater than 1% of a total mass of the positive electrode active layer.

The inventors have found through research that the element Al helps improve structural stability of a positive electrode active material. Therefore, to further improve cycling performance of a lithium-ion battery, the positive electrode active material includes the element Al. In addition, as a doping amount of the element Al increases, stability of the positive electrode active material also improves, and the value of (A−B) decreases. Therefore, the doping amount of the element Al is not less than 3500 ppm, that is, content of the element Al/total content of the positive electrode active material ≥3500 ppm.

A compound that includes the element Al may be an aluminum salt and/or an aluminum oxide. For example, the compound that includes the element Al may be one or more of Al₂(SO₄)₃, AlCl₃, or Al₂O₃, and an addition amount thereof may be adjusted according to a content of the element Al.

The positive electrode active material may be obtained by using the foregoing method. Since final particle size distribution of the positive electrode active material affects compaction of a positive electrode plate and performance of the lithium-ion battery, a median particle size by volume Dv50 of the positive electrode active material ranges from 8.0 μm to 15.0 μm. Dv50 refers to the particle size of a sample corresponding to the cumulative volume particle size distribution percentage of 50%. The physical significance is that a volume of particles greater than Dv50 accounts for 50%, and a volume of particles less than Dv50 account for 50%. Dv50 is also known as median diameter or median value of particle size distribution. Dv50 is commonly used to represent the average particle size of the powder. Based on the average particle size, a person skilled in the art may select a particle size of a raw material or grind a calcined positive electrode active material to meet a requirement of a final active material particle size.

In addition, to consider both high-low temperature performance of the lithium-ion battery and compaction of the positive electrode plate, the positive electrode active material may be obtained by performing gradation on large particles and small particles. The large particles refer to particles with a median particle size by volume Dv50 ranging from 8.0 μm to 18.0 μm, and the small particles refer to particles with a median particle size by volume Dv50 ranging from 2.0 μm to 6.0 μm.

After the positive electrode active material is prepared, the positive electrode active material, a conductive agent, and a binder are dispersed in a solvent to obtain a positive electrode active layer slurry, and the positive electrode active layer slurry is evenly applied on a surface of a positive electrode current collector to obtain a positive electrode plate. Specifically, the positive electrode active layer slurry includes 70-99 wt. % positive electrode active material, 0.5-15 wt. % conductive agent, and 0.5-15 wt. % binder according to mass percentage. Further, the positive electrode active layer slurry includes 80-98 wt. % positive electrode active material, 1-10 wt. % conductive agent, and 1-10 wt. % binder according to mass percentage.

The conductive agent is selected from one or more of conductive carbon black, acetylene black, Ketjen black, conductive graphite, conductive carbon fiber, carbon nanotube, metal powder, or carbon fiber. The binder is selected from one or more of polyvinylidene fluoride (PVDF), polytetrafluoroethylene (PTFE), or lithium polyacrylate (PAALi).

The lithium-ion battery further includes a negative electrode plate, a separator, and an electrolyte. Specifically, the negative electrode plate includes a negative electrode current collector and a negative electrode active layer, and the negative electrode active layer includes a negative electrode active material, a conductive agent, and a binder. A preparation method for the negative electrode active layer is the same as a preparation method for a positive electrode active layer. A negative electrode active layer slurry includes 70-99 wt. % negative electrode active material, 0.5-15 wt. % conductive agent, and 0.5-15 wt. % binder according to mass percentage. Further, the negative electrode active layer slurry includes 80-98 wt. % negative electrode active material, 1-10 wt. % conductive agent, and 1-10 wt. % binder according to mass percentage.

The selection of the conductive agent and the binder is the same as that of the positive electrode plate, and the negative electrode active material is selected from one or more of artificial graphite, natural graphite, hard carbon, mesocarbon microbead, lithium titanate, silicon carbon, or silicon monoxide.

The electrolyte includes anon-aqueous solvent, a conductive lithium salt, and an additive. The non-aqueous solvent is a mixture of a cyclic carbonate and at least one of linear carbonate and linear carboxylate in any proportion. The cyclic carbonate is selected from ethylene carbonate and/or propylene carbonate. The linear carbonate is selected from one or more of dimethyl carbonate, diethyl carbonate, or ethyl methyl carbonate. The linear carboxylate is selected from one or more ethyl propionate, propyl propionate or propyl acetate. The conductive lithium salt is selected from one or more of lithium hexafluorophosphate, lithium bis(fluorosulfonyl)imide, and lithium bistrifluoromethanesulfonimidate. The additive includes one or more of a nitrile compound, vinylene carbonate, or 1,3-propene sultone.

Assuming that a total volume of a non-aqueous organic solvent is 100 vol %, a volume fraction of the cyclic carbonate ranges from 20 vol % to 40 vol %, and a volume fraction of the linear carbonate and/or the linear carboxylate ranges from 60 vol % to 80 vol %.

The separator is a polypropylene film, or a polypropylene film with at least one surface coated with ceramic.

A positive electrode, a separator, and a negative electrode are stacked or wound to obtain a battery cell, the battery cell is packaged, and an electrolyte is injected. In this way, a lithium-ion battery may be obtained. A person skilled in the art may explore a charge and discharge regime of the lithium-ion battery by using a conventional technical means. The inventors have found through research that, in a process of charging and discharging of the lithium-ion battery, a charge cut-off voltage, a charge cut-off current, and a charging and discharging temperature are important factors that affect the value of (A−B). For example, as the charge cut-off voltage increases, the value of (A−B) also gradually increases; as the charge cut-off current increases, the value of (A−B) gradually decreases; as the charging and discharging temperature continuously increases, the value of (A−B) continuously increases. Therefore, when charging and discharging of the lithium-ion battery is performed, the charge cut-off voltage of the lithium-ion battery is less than 4.5 V; the charge cut-off current of the lithium-ion battery is not less than 0.02 C; and the charging and discharging temperature of the lithium-ion battery is less than 45° C.

After a proper charge and discharge regime is determined, the lithium-ion battery is charged and discharged according to the charge and discharge regime. When the lithium-ion battery is in an SOC of 0%, a molar ratio of an element lithium to an element cobalt in the positive electrode active material is A, and when the lithium-ion battery is in an SOC of 100%, a molar ratio of the element lithium to the element cobalt in the positive electrode active material is B. When 0.62≤(A−B)≤0.655, it indicates that the lithium-ion battery including the positive electrode active material has good cycling performance in the charge and discharge regime; otherwise, a doping and coating content and/or the charge and discharge regime in the positive electrode active material need to be adjusted to meet a requirement of 0.62≤(A−B)≤0.655.

The molar ratio of the element lithium to the element cobalt in the positive electrode active material for the lithium-ion battery in each of the SOC of 0% and the SOC of 100% may be obtained by means of an ICP(Inductively Coupled Plasma) test.

In conclusion, the present disclosure provides a lithium-ion battery. When the lithium-ion battery is in an SOC of 0%, a molar ratio of an element lithium to an element cobalt in the positive electrode active material is A, and when the lithium-ion battery is in an SOC of 100%, a molar ratio of the element lithium to the element cobalt in the positive electrode active material is B. When 0.62≤(A−B)≤0.655, the lithium-ion battery has good cycling performance.

### DETAILED DESCRIPTIONS OF THE EMBODIMENTS

To make the objectives, technical solutions, and advantages of the present disclosure clearer, the following clearly describes the technical solutions in the embodiments of the present disclosure with reference to the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

### Example 1

This example provides a lithium-ion battery, including a positive electrode plate, a separator, a negative electrode plate, and an electrolyte. The positive electrode plate includes an aluminum foil and a positive electrode active layer. The positive electrode active layer includes a positive electrode active material, and the negative electrode plate includes a copper foil and a negative electrode active layer. Specifically, the positive electrode active layer includes a positive electrode active material, the positive electrode active material includes lithium cobalt oxide particles doped with three elements of Al, Mg, and Ti, and a coating layer, where the coating layer includes magnesium oxide and titanium oxide.

A method for preparing the positive electrode active material provided in this example includes the following steps.

Step 1-1: Dissolving CoCl₂ in an aqueous solution to obtain a salt solution with Co²⁺ concentration of 1.25 mol/L, preparing a complexing agent solution (with concentration ranging from 2% to 2.5%) with concentrated aqueous ammonia and distilled water at a volume ratio of 1:10, and dissolving sodium carbonate in the aqueous solution to prepare a sodium carbonate solution with a concentration of 1.2 mol/L; injecting ⅓ sodium carbonate solution into a reactor, under a strong stirring action and protection of inert gas, continuing to simultaneously inject the cobalt salt solution, the complexing agent solution, and the remaining ⅔ sodium carbonate solution into the reactor in a parallel flow control mode while stirring, where a speed of parallel flow control is no more than 200 L/h and a stirring speed does not exceed 200 rpm, and controlling a pH value of a reaction system to range from 6 to 12, and controlling a temperature of the reactor to range from 70° C. to 80° C. during reaction; and monitoring a liquid phase ion concentration of element Co in the reaction system in real time during the reaction, and performing centrifugal filtration after continuous reaction and repeated crystallization for three times to obtain cobalt carbonate CoCO₃.

Step 1-2: Calcining the cobalt carbonate CoCO₃ in a muffle furnace at 930° C. for 10 hours, and then pulverizing the calcined product to obtain a precursor CO₃O₄ with particles uniformly distributed.

Step 1-3: Mixing the prepared precursor CO₃O₄, Li₂CO₃, Al₂(SO₄)₃, MgSO₄, and TiO₂, where Co:Al:Mg:Ti=0.9935:0.0045:0.001:0.001, and a molar ratio of Li to Co is 100:99.6; and after physical mixing, calcining the mixed substance in a muffle furnace at 1035° C. for 11 hours, and then pulverizing the calcined product to obtain lithium cobalt oxide particles uniformly distributed in particles and doped with an element M.

Step 2: Weighing magnesium oxide, titanium oxide, and lithium cobalt oxide particles doped with the element M according to a molar ratio of Mg:Ti:lithium cobalt oxide particles doped with the element M=0.5:0.5:99.5 to be uniformly mixed by stirring, calcining the mixture in a muffle furnace at 950° C. for 8 hours, and pulverizing the calcined product to obtain the positive electrode active material.

A median particle size by volume Dv50 of the positive electrode active material is 14.5 μm.

97 parts by mass of the positive electrode active material, 1.5 parts by mass of conductive agent Super-P, and 1.5 parts by mass of binder polyvinylidene fluoride (PVDF) were dispersed in N-methylpyrrolidone (NMP) to obtain a positive electrode active layer slurry. The slurry was uniformly applied on a surface of aluminum foil, and then rolled up after being baked in a five-stage oven, with temperatures of the five-stage oven set at 70° C., 80° C., 95° C., 120° C., and 120° C., respectively. Then, a current collector coated with the positive electrode active layer slurry was baked in an oven at 100° C. for 8 hours, and then was rolled after a solvent in the positive electrode active layer slurry was completely evaporated, to obtain the positive electrode plate with a compacted density of 4.1 g/cm³.

96 parts by mass of negative electrode active material artificial graphite (Dv50: 13±1 μm, graphitization degree: 94±0.5%, and secondary particles mixed with single particles, in which a mass percentage of the secondary particles is 50%), 1 part by mass of superconducting carbon black (Super-P), 1.5 parts by mass of sodium carboxymethyl cellulose (CMC), and 1.5 parts by mass of styrene butadiene rubber (SBR) were dispersed in a solvent to obtain a negative electrode active layer slurry. The negative electrode active layer slurry was applied on 8 μm copper foil and dried at 100° C., and after being baked for 4 hours, the copper foil was rolled to obtain the negative electrode plate with a compacted density of 1.68 g/cm³. “Single particle” refer to a single negative active particle. “Secondary particles” refer to particles formed by agglomeration of a number of single particles. For example, the secondary particles are particles formed by agglomerating 2, 5, 10 or more single particles.

The separator is a single-sided ceramic+double-sided oil LBG coating separator.

The electrolyte solution includes a non-aqueous organic solvent, a lithium salt, and an additive. The non-aqueous organic solvent includes ethylene carbonate (EC), propylene carbonate (PC), and dimethyl carbonate (DMC) (with a mass ratio of 1:1:1); the lithium salt is LiPF₆; and the additive includes 4 wt. % 1,3-propene sultone, 6 wt. % vinylene carbonate, 1 wt. % succinonitrile, and 2 wt. % adiponitrile.

The positive electrode plate, the negative electrode plate, and the separator were wound to form a battery cell; the battery cell was packaged by using an aluminum-plastic film, and baked for 36 hours in a nitrogen-protected oven at a controlled temperature of 120° C.; and after the electrolyte was injected, processes such as formation and sorting were performed to finally obtain a pouch lithium-ion battery with a capacity of 5 Ah.

The battery prepared above was charged and discharged at 25° C. The battery was discharged to 3.0 V at a rate of 0.7 C. The battery cell was disassembled to test contents of Li and Co, and then A was calculated. The battery was charged to 4.45 V at a constant current rate of 0.7 C, and then charged at a constant voltage with a cut-off current of 0.1 C. The battery cell in this state was disassembled to test the contents of Li and Co, and then B was calculated.

A cycle test, that is, at 0.7 C/0.7 C, and a cut-off current of 0.1 C, was performed on the lithium-ion battery according to the foregoing charge and discharge regime, where the voltage ranges from 3.0 V to 4.45 V, and the temperature is 25° C. A capacity retention rate was tested after 500T cycles.

An ICP test was performed on the positive electrode active material. The test result shows that total contents of Al, Mg, and Ti in the positive electrode active material are 4500 ppm, 1500 ppm, and 1500 ppm, respectively.

The ICP test method specifically includes the following steps.

1. Disassembling the lithium-ion battery prepared above, retaining the disassembled positive electrode plate, soaking the positive electrode plate in a solution of dimethyl carbonate (DMC) for 30 minutes, then taking out the positive electrode plate, and drying the positive electrode plate in an oven at 120° C. for 6 hours.

2. Sintering the dried positive electrode plate in a tube furnace at a high temperature, where a sintering temperature of the tube furnace is set to 300° C. and a sintering time is set to 4 hours; cooling the positive electrode plate naturally after sinter; and putting the positive electrode plate into a sealed glass bottle.

3. Placing the glass bottle with the positive electrode plate in an ultrasonic machine for ultrasonic treatment, 15 minutes later, taking out and rubbing the positive electrode plate gently, to obtain positive electrode powder.

4. Testing the foregoing positive electrode powder by using an atomic absorption spectrometer (ICP) to obtain a content value of each element, where a spectral line of each element is shown in Table 1.

TABLE 1
Spectral lines of elements in the positive electrode active material

| Element | Li | Co | Al | Mg | Ti |
|---|---|---|---|---|---|
| Spectral line (nm) | 670.784 | 228.616 | 396.15 | 279.553 | 323.5 |
| STD1 | 0 | 0 | 0 | 0 | 0 |
| STD2 | 1 | 10 | 1 | 1 | 1 |
| STD3 | 3 | 30 | 2 | 2 | 2 |
| STD4 | 10 | 100 | 5 | 5 | 5 |

### Example 2

The lithium-ion battery provided in this example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery was charged to 4.45 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.45 V, and the temperature is 25° C. A capacity retention rate was tested after 500T cycles.

### Example 3

The lithium-ion battery provided in this example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery was charged to 4.45 V at a constant current rate of 0.7 C and then charged at a constant voltage with a cut-off current of 0.02 C. The battery cell in this state was disassembled to test the contents of Li and Co, and then B was calculated.

A cycle test, that is, at 0.7 C/0.7 C, and a cut-off current of 0.02 C, was performed on the lithium-ion battery according to the foregoing charge and discharge regime, where the voltage ranges from 3.0 V to 4.45 V, and the temperature is 25° C. A capacity retention rate was tested after 500T cycles.

### Example 4

The lithium-ion battery provided in this example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery was charged to 4.4 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.4 V, and the temperature is 25° C. A capacity retention rate was tested after 500T cycles.

### Example 5

The lithium-ion battery provided in this example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery was charged to 4.48 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.48 V, and the temperature is 25° C. A capacity retention rate was tested after 500T cycles.

### Example 6

The lithium-ion battery provided in this example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and at 10° C., the battery was charged to 4.45 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.45 V, and the temperature is 10° C. A capacity retention rate was tested after 500T cycles.

### Example 7

The lithium-ion battery provided in this example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and at 35° C., the battery was charged to 4.45 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.45 V, and the temperature is 35° C. A capacity retention rate was tested after 500T cycles.

### Example 8

For the lithium-ion battery provided in this example, reference may be made to Example 2. A difference lies in that total contents of Al, Mg, and Ti in the positive electrode active material are 3500 ppm, 1500 ppm, and 1500 ppm, respectively.

The lithium-ion battery was charged and discharged by using the charge and discharge regime provided in Example 2, and a capacity retention rate was tested.

### Example 9

For the lithium-ion battery provided in this example, reference may be made to Example 2. A difference lies in that total contents of Al, Mg, and Ti in the positive electrode active material are 4000 ppm, 1500 ppm, and 1500 ppm, respectively.

The lithium-ion battery was charged and discharged by using the charge and discharge regime provided in Example 2, and a capacity retention rate was tested.

### Example 10

For the lithium-ion battery provided in this example, reference may be made to Example 2. A difference lies in that total contents of Al, Mg, and Ti in the positive electrode active material are 5000 ppm, 1500 ppm, and 1500 ppm, respectively.

The lithium-ion battery was charged and discharged by using the charge and discharge regime provided in Example 2, and a capacity retention rate was tested.

### Example 11

For the lithium-ion battery provided in this example, reference may be made to Example 2. A difference lies in that total contents of Al, Mg, and Ti in the positive electrode active material are 5500 ppm, 1500 ppm, and 1500 ppm, respectively.

The lithium-ion battery was charged and discharged by using the charge and discharge regime provided in Example 2, and a capacity retention rate was tested.

### Example 12

For the lithium-ion battery provided in this example, reference may be made to Example 2. A difference lies in that total contents of Al, Mg, and Ti in the positive electrode active material are 6000 ppm, 1500 ppm, and 1500 ppm, respectively.

The lithium-ion battery was charged and discharged by using the charge and discharge regime provided in Example 2, and a capacity retention rate was tested.

### Example 13

For the lithium-ion battery provided in this example, reference may be made to Example 2. A difference lies in that total contents of Al, Mg, and Ti in the positive electrode active material are 7000 ppm, 1500 ppm, and 1500 ppm, respectively.

The lithium-ion battery was charged and discharged by using the charge and discharge regime provided in Example 2, and a capacity retention rate was tested.

### Comparative Example 1

The positive electrode active material provided in this comparative example is lithium cobalt oxide, and for preparation and a charge and discharge regime of the lithium-ion battery, reference may be made to Example 2.

A method for preparing the positive electrode active material provided in this comparative example includes the following steps.

Step 1: Dissolving CoCl₂ in an aqueous solution to obtain a solution with Co²⁺ concentration of 1.25 mol/L; mixing an aqueous ammonia solution (concentrated aqueous ammonia and distilled water are prepared at a volume ratio of 1:10) and a sodium carbonate solution (1.2 mol/L), and performing complex precipitation reaction; and performing centrifugal filtration after continuous reaction and repeated crystallization for three times to obtain cobalt carbonate CoCO₃.

Step 2: Calcining the cobalt carbonate in a muffle furnace at 930° C. for 10 hours, and then pulverizing the calcined product to obtain a precursor CO₃O₄ with particles uniformly distributed.

Step 3: Mixing the prepared precursor CO₃O₄ and Li₂CO₃ by high-speed ball milling according to Li:Co=100:99.6, calcining the mixture in a muffle furnace at 1035° C. for 11 hours, and then pulverizing the calcined product to obtain LiCoO₂.

### Comparative Example 2

The lithium-ion battery provided in this comparative example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery was charged to 4.45 V at a constant current rate of 0.7 C and then charged at a constant voltage with a cut-off current of 0.01 C. The battery cell in this state was disassembled to test the contents of Li and Co, and then B was calculated.

A cycle test, that is, at 0.7 C/0.7 C, and a cut-off current of 0.01 C, was performed on the lithium-ion battery according to the foregoing charge and discharge regime, where the voltage ranges from 3.0 V to 4.45 V, and the temperature is 25° C. A capacity retention rate was tested after 500T cycles.

### Comparative Example 3

The lithium-ion battery provided in this comparative example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery in a same group was charged to 4.5 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.5 V, and the temperature is 25° C. A capacity retention rate was tested after 500T cycles.

### Comparative Example 4

The lithium-ion battery provided in this comparative example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and the battery was charged to 4.55 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.55 V, and the temperature is 25° C. A capacity retention rate was tested after 500T cycles.

### Comparative Example 5

The lithium-ion battery provided in this comparative example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and at 45° C., the battery was charged to 4.45 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.45 V, and the temperature is 45° C. A capacity retention rate was tested after 500T cycles.

### Comparative Example 6

The lithium-ion battery provided in this comparative example is the same as that in Example 1, and a difference lies in charge and discharge regimes. Specifically, at 25° C., a battery cell was discharged to 3.0 V at a rate of 0.7 C and disassembled to test contents of Li and Co, and then A was calculated; and at 55° C., the battery was charged to 4.45 V at a constant current rate of 0.7 C and then charged at a constant voltage with a cut-off current of 0.05 C. The battery cell in this state was disassembled to test the contents of Li and Co, and then B was calculated.

A cycle test, that is, at 0.7 C/0.7 C, and a cut-off current of 0.05 C, was performed on the lithium-ion battery according to the foregoing charge and discharge regime, where the voltage ranges from 3.0 V to 4.45 V, and the temperature is 55° C. A capacity retention rate was tested after 500T cycles.

Table 2 to Table 5 illustrate the positive electrode active materials and charge and discharge regimes that are provided in Examples 1-13 and Comparative Examples 1-6, and list the capacity retention rate of the lithium-ion batteries that are provided in Examples 1-13 and Comparative Examples 1-6, so that differences and effects of the examples provided in the present disclosure are more intuitive.

TABLE 2
the value of (A − B) and capacity retention rate of the lithium-
ion batteries in Examples 1-3 and Comparative Examples 1 and 2

| | | | | Capacity | | |
|---|---|---|---|---|---|---|
| | | | | retention | Charge cut- | |
| | A | B | (A − B) | rate | off current | |
| Example 1 | 0.926 | 0.301 | 0.625 | 93.01% | 0.1 | C |
| Example 2 | 0.926 | 0.287 | 0.639 | 91.46% | 0.05 | C |
| Example 3 | 0.926 | 0.280 | 0.646 | 88.44% | 0.02 | C |
| Comparative | 0.913 | 0.253 | 0.660 | 86.74% | 0.05 | C |
| Example 1 | | | | | | |
| Comparative | 0.926 | 0.269 | 0.657 | 87.76% | 0.01 | C |
| Example 2 | | | | | | |

The lithium-ion batteries were cycled within a voltage range of 3.0 V-4.45 V at 25° C., a charge and discharge rate of the lithium-ion batteries was ensured to be consistent, and the charge cut-off current of the lithium-ion batteries was adjusted to 0.1 C, 0.05 C, 0.02 C, and 0.1 C. It may be learned from data provided in Examples 1-3 and Comparative Example 2 that, as the charge cut-off current decreases, the value of (A−B) becomes larger, the capacity retention rate decreases, and cycling performance deteriorates.

TABLE 3
the value of (A − B) and capacity retention
rate of the lithium-ion batteries in Examples
2, 4, and 5 and Comparative Examples 1, 3, and 4

| | | | | Capacity | | |
|---|---|---|---|---|---|---|
| | | | | retention | Charge cut- | |
| | A | B | (A − B) | rate | off voltage | |
| Example 2 | 0.926 | 0.287 | 0.639 | 91.46% | 4.45 | V |
| Example 4 | 0.926 | 0.320 | 0.606 | 94.08% | 4.4 | V |
| Example 5 | 0.926 | 0.271 | 0.655 | 89.81% | 4.48 | V |
| Comparative | 0.913 | 0.253 | 0.660 | 86.74% | 4.45 | V |
| Example 1 | | | | | | |
| Comparative | 0.926 | 0.263 | 0.663 | 82.56% | 4.5 | V |
| Example 3 | | | | | | |
| Comparative | 0.926 | 0.237 | 0.689 | 80.23% | 4.55 | V |
| Example 4 | | | | | | |

The lithium-ion batteries were charged and discharged at a rate of 0.7 C/0.7 C at 25° C., the charge cut-off current was always 0.05 C, and the cut-off voltage was adjusted to 4.4 V, 4.45 V, 4.48 V, 4.5 V, and 4.55 V. It may be learned from data provided in Examples 2, 4, and 5, and Comparative Examples 3 and 4 that, as the charge cut-off current increases, the value of (A−B) becomes larger, the capacity retention rate decreases, and cycling performance deteriorates.

TABLE 4
the value of (A − B) and capacity retention
rate of the lithium-ion batteries in Examples
2, 6, and 7 and Comparative Examples 1, 5 and 6

| | | | | Capacity | |
|---|---|---|---|---|---|
| | | | | retention | Cycle |
| | A | B | (A − B) | rate | temperature |
| Example 2 | 0.926 | 0.287 | 0.639 | 95.08% | 25° C. |
| Example 6 | 0.926 | 0.310 | 0.615 | 96.44% | 10° C. |
| Example 7 | 0.926 | 0.279 | 0.646 | 92.69% | 35° C. |
| Comparative | 0.913 | 0.253 | 0.660 | 91.62% | 25° C. |
| Example 1 | | | | | |
| Comparative | 0.926 | 0.245 | 0.681 | 90.48% | 45° C. |
| Example 5 | | | | | |
| Comparative | 0.926 | 0.205 | 0.721 | 85.25% | 55° C. |
| Example 6 | | | | | |

At 10° C., 25° C., 35° C., 45° C., and 55° C., the lithium-ion batteries were charged and discharged in a range of 3.0 V-4.45 V and at 0.7 C/0.7 C, and the cut-off current was 0.05 C. It may be learned from data provided in Examples 2, 6, and 7, and Comparative Examples 5 and 6 that, as the cycle temperature increases, the value of (A−B) becomes larger, the capacity retention rate decreases, and cycling performance deteriorates.

TABLE 5
the value of (A − B) and capacity retention rate of the
lithium-ion batteries in Examples 2, 8-13 and Comparative Example 1

| | | | | Capacity | |
|---|---|---|---|---|---|
| | | | | retention | Al content |
| | A | B | (A − B) | rate | (ppm) |
| Example 2 | 0.926 | 0.287 | 0.639 | 91.46% | 4500 |
| Example 8 | 0.921 | 0.266 | 0.655 | 88.22% | 3500 |
| Example 9 | 0.925 | 0.274 | 0.651 | 89.81% | 4000 |
| Example 10 | 0.929 | 0.302 | 0.627 | 92.12% | 5000 |
| Example 11 | 0.931 | 0.311 | 0.62 | 93.01% | 5500 |
| Example 12 | 0.934 | 0.317 | 0.617 | 94.98% | 6000 |
| Example 13 | 0.936 | 0.335 | 0.601 | 96.14% | 7000 |
| Comparative | 0.913 | 0.253 | 0.66 | 86.74% | 0 |
| Example 1 | | | | | |

A doping amount of the element Al in the positive electrode active material is adjusted to 3500 ppm, 4000 ppm, 4500 ppm, 5000 ppm, 5500 ppm, 6000 ppm, and 7000 ppm, and the lithium-ion batteries including the foregoing positive electrode active material were charged and discharged in a same condition. It may be learned from data provided in Examples 2 and 8-13 that, as the doping amount of the element Al in the positive electrode active material increases, the value of (A−B) decreases, the capacity retention rate increases, and cycling performance is improved.

In conclusion, when the lithium-ion battery is in an SOC of 0%, the molar ratio of the element lithium to the element cobalt in the positive electrode active material is A; when the lithium-ion battery is in an SOC of 100%, the molar ratio of the element lithium to the element cobalt in the positive electrode active material is B. When 0.62≤(A−B)≤0.655, the lithium-ion battery has better cycling performance.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of the present disclosure.

What is claimed is:

1. A lithium-ion battery, wherein the lithium-ion battery comprises a positive electrode active material, the positive electrode active material comprises lithium cobalt oxide particles doped with one or more elements of Al, Mg, Ti, Zr, Ni, Mn, Y, La, Sr, W, or Sc, when the lithium-ion battery is in a state of charge (SOC) of 0%, a molar ratio of an element lithium to an element cobalt in the positive electrode active material is A, and when the lithium-ion battery is in an SOC of 100%, a molar ratio of the element lithium to the element cobalt in the positive electrode active material is B, and 0.62≤(A−B)≤0.655.

2. The lithium-ion battery according to claim 1, wherein the positive electrode active material further comprises a coating layer covering at least part of an outer surface of the lithium cobalt oxide particles, and the coating layer comprises one or more of a metal fluoride, a metal oxide, a metal borate compound, or a metal phosphate compound.

3. The lithium-ion battery according to claim 2, wherein the metal fluoride is selected from one or more of AlF₃, Li₃F, or MgF.

4. The lithium-ion battery according to claim 2, wherein the metal oxide is selected from one or more of Al₂O₃, TiO₂, ZrO₂, or MgO.

5. The lithium-ion battery according to claim 2, wherein the metal borate compound is AlBO₃.

6. The lithium-ion battery according to claim 2, wherein the metal phosphate compound is selected from one or two of AlPO₄ or Li₃PO₄.

7. The lithium-ion battery according to claim 2, wherein the positive electrode active material comprises an element Al, and a content of the element Al is not less than 3500 ppm.

8. The lithium-ion battery according to claim 2, wherein a mass of the coating layer is not greater than 1% of a total mass of the positive electrode active material.

9. The lithium-ion battery according to claim 2, wherein the thickness of the coating layer is not greater than 50 nm.

10. The lithium-ion battery according to claim 2, wherein the positive electrode active material is prepared according to a following preparation method:
adding an element M to the lithium cobalt oxide particles, the element M comprises one or more of Al, Mg, Ti, Zr, Ni, Mn, Y, La, Sr, W, or Sc; and
covering, with one or more of a metal fluoride, a metal oxide, a metal borate compound, or a metal phosphate compound, at least part of a surface of lithium cobalt oxide particles doped with the element M to form a coating layer, so as to obtain the positive electrode active material.

11. The lithium-ion battery according to claim 2, wherein a median particle size by volume Dv50 of the positive electrode active material ranges from 8.0 μm to 15.0 μm.

12. The lithium-ion battery according to claim 2, wherein the positive electrode active material comprises large particles and small particles.

13. The lithium-ion battery according to claim 2, wherein the large particles refer to particles with a median particle size by volume Dv50 ranging from 8.0 μm to 18.0 μm, and the small particles refer to particles with a median particle size by volume Dv50 ranging from 2.0 μm to 6.0 μm.

14. The lithium-ion battery according to claim 1, wherein the positive electrode active material comprises lithium cobalt oxide particles doped with one or more elements of Al, Mg, or Ti.

15. The lithium-ion battery according to claim 1, wherein a charge cut-off voltage of the lithium-ion battery is less than 4.5 V.

16. The lithium-ion battery according to claim 1, wherein a charge cut-off current of the lithium-ion battery is not less than 0.02 C.

17. The lithium-ion battery according to claim 1, wherein a charging and discharging temperature of the lithium-ion battery is less than 45° C.

18. The lithium-ion battery according to claim 1, comprising a negative electrode active material, wherein the negative electrode active material is selected from one or more of artificial graphite, natural graphite, hard carbon, mesocarbon microbead, lithium titanate, silicon carbon, or silicon monoxide.

19. The lithium-ion battery according to claim 1, comprising an electrolyte, wherein the electrolyte comprises a non-aqueous solvent, a conductive lithium salt, and an additive.

20. The lithium-ion battery according to claim 19, wherein the non-aqueous solvent is a mixture of a cyclic carbonate and at least one of linear carbonate and linear carboxylate in any proportion;
and/or, the conductive lithium salt is selected from one or more of lithium hexafluorophosphate, lithium bis(fluorosulfonyl)imide, and lithium bistrifluoromethanesulfonimidate;
and/or, the additive comprises one or more of a nitrile compound, vinylene carbonate, or 1,3-propene sultone.
